(19) United States
(12) Patent Application Publication
(10) Pub. No.: US 2008/0304113 A1
(43) Pub. Date: Dec. 11, 2008

(54) Space font: using glyphless font for searchable text documents

(75) Inventors: Donald J. Curry, Menlo Park, CA (US); Asghar Nafarieh, Menlo Park, CA (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/810,470

(22) Filed: Jun. 6, 2007

(51) Int. Cl. H04N 1/00

(52) U.S. Cl. 358/426.12

(57) ABSTRACT

Systems and methods are described that facilitate mitigating searchable electronic document size increases associated with embedded font definition files by embedding only font size information. When a document is scanned or converted into a PDF or XPS document image, glyphless font size information describing character dimensions for fonts used in the document is embedded into the document image. The glyphless font size information is on the order of a few kilobytes in size, and is later read by a searcher to facilitate highlighting search terms identified in the document image in response to a user query. A highlight block is generated to have a width substantially equal to the combined widths of the characters in the queried term, which are described in the glyphless font information. The highlight block is then overlaid on the image of the queried term, and presented to the user.

### BACKGROUND

The subject application relates to searchable electronic documents, and more particularly to reducing file size of searchable electronic document while improving ability to identify a searched term.

When scanning or otherwise generating searchable electronic documents, information can be stored in a variety of file formats, such as a portable document format (PDF) and extensible markup language paper specification format (XPS), or the like. Some versions of electronic documents are searchable, such that a user is permitted to enter a term, and a software application searches the document and identifies any instances of the text term to the user. However, conventional searchable electronic document systems and methods require embedding one or more relatively large font definition files into the electronic document to enable searching. When the purpose of storing the document in image form, as a PDF or XPS document is to reduce file size, embedding a large font definition file runs contrary to the intended purpose of such applications.

Accordingly, there is an unmet need for systems and/or methods that facilitate overcoming the aforementioned deficiencies.

### BRIEF DESCRIPTION

In accordance with various aspects described herein, systems and methods are described that facilitate minimizing additional font information embedded into a searchable electronic document image using a glyphless font technique. For example, a method of highlighting a searched term in an electronic document image comprises receiving a search query for a term in the document image, reading glyphless font size information embedded in the document image, and determining at least one dimension for a highlight block for the search term from the glyphless font size information. The method further comprises identifying the search term in the document image, and overlaying the highlight block on the identified search term.

According to another feature described herein, a system that facilitates highlighting search terms in an electronic document image comprises a scanner that scans a document and embeds glyphless font size information into an electronic image of the document, a searcher with an optical character recognition (OCR) component that identifies a search term in the document image in response to a user query, and a processor that generates a highlight block of a variable width and overlays the highlight block on identified search terms in the document image.

### BRIEF DESCRIPTION OF THE DRAWINGS

FIG. 1 illustrates a system that facilitates employing a glyphless “dummy” font information to provide text character size information without significantly impacting document file size;

FIG. 2 illustrates a high level block diagram of a system that facilitates highlighting identified search results in an electronic document image for presentation to a user, using glyphless font information embedded in the document image;

FIG. 3 illustrates a method of minimizing increases to a scanned document image file size while providing sufficient font size information to facilitate highlighting search terms identified in the document image in response to a user query;

FIG. 4 is an illustration of a method of employing glyphless font information to identify text search results in an electronic image of a document, without a font definition file embedded in the image of the document;

FIG. 5 illustrates a method of providing extended glyphless font size information, in addition to simple character dimension information, without embedding a full font definition file, to facilitate presenting highlighted search term results to a user;

FIG. 6 illustrates several examples of search results that can be presented by the systems and methods described herein, as well as one example of an undesirable search result presentation that is mitigated by the systems and methods described herein.

### DETAILED DESCRIPTION

In accordance with various features described herein, systems and methods are described that facilitate mitigating searchable electronic document size increases associated with embedded font definition files by embedding only font size information. For example, scanned document size, when stored in PDF or XPS format, increases when an optical character recognition (OCR) technique is employed to search and/or identify terms in the document. Typically, all fonts referenced or used in the document are stored with the document to facilitate such searches, which contributes substantially to document size. For instance, each embedded font definition file can add hundreds or thousands of kilobytes to the document size. Such size increases are undesirable when considering that the font definition file is so large compared to the compressed document image file size. Accordingly, systems and methods are described herein that facilitate embedding only font size information, using a “glyphless” font.

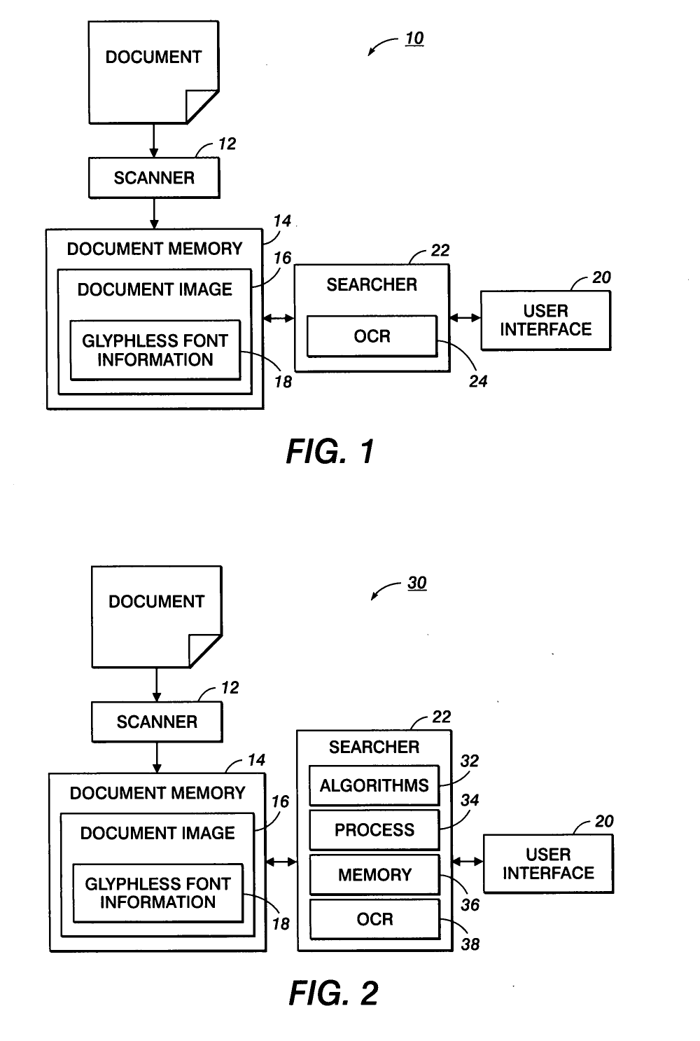

With reference to FIG. 1, a system 10 is illustrated that facilitates employing glyphless “dummy” font information to provide text character size information without significantly impacting document file size. For example, well-segmented and compressed scanned images can be very small in size. When it is desirable to incorporate optical character-recognized text into the document to provide a searchable text feature, file size increases because the entire font definition file is embedded in the document using conventional techniques. However, since characters in a PDF or XPS format are represented as a transparent overlay, only compressed images of the text are visible. Accordingly, a dummy font containing only character size information, having no visible glyph data, and having a total size on the order of a few kilobytes, can be employed to communicate basic font metrics (e.g., height and width of characters). This dummy font can be utilized to generate a highlight block that is overlaid on a queried term that is located in the document image to highlight the term.

The dummy font is an empty font that contains only font size information but does not render text. Rather, the dummy font only renders the space that the text would occupy, in a different color than the background image, without rendering the text characters itself. Accordingly the systems and methods described herein have application in for document images in any language, and can be especially useful, for example, in PDF or XPS document image searching when such documents are in languages not supported PDF or XPS.

The system 10 comprises a scanner 12 that receives a document and generates a scanned document image (e.g., a PDF image, an XPS image, or some other scanned image type). In one example, the scanner 12 is a physical scanner that receives a physical document and generates an image thereof. In other examples, the scanner 12 is a software-based scanner, such as a conversion program that converts an electronic document from a document generation application format (e.g., a word-processing application, a graphical drawing application, or the like) into an electronic image document. In either case, the scanner 12 is coupled to a document memory 14, which stores a document image 16 containing glyphless, or dummy, font information 18 describing the font(s) used in the scanned document.

The system 10 further comprises a user interface 20 such as a computing device (e.g., a personal computer, a laptop or tablet PC, a PDA, a cell phone or the like), which displays information to a user and into which the user may enter information. According to an example, the user views the document image(s), representing pages of the physical document scanned into the scanner 12, on the user interface. The user enters a search query for a given word into the user interface 20, which is received by a searcher 22 that executes one or more algorithms to search the document image 16 for the queried term. For instance, the searcher 22 can include an OCR component 24 that recognizes text words in the document that match the queried term and returns results to the user interface 20 for presentation to the user. The identified query results from the OCR component 24 can then be efficiently highlighted by the searcher 22 for the user using the dummy font information to determine an appropriately sized highlight block to overlay on the compressed text image representing the identified query result. In this example, the OCR component 24 analyzes beginnings and ends of characters in a bitmap. The embedded glyphless font includes size and scale for each font used in the document image, and the OCR component reads the font size information for scaling for the searcher 22. Glyph information is not needed because the searched term is not being rendered, but rather is being overlaid with a highlight block of appropriate size.

In another example, the glyphless dummy font information comprises information describing character width and height for bolded characters in addition to non-bolded characters. According to still other features, the dummy font information includes rotation information that describes an angle or degree if slant for italicized text characters. In this manner, the system 10 facilitates permitting a user to search the scanned document image for a word or other text, and to receive highlighted search results without requiring large font definition files to be embedded in the document image.

FIG. 2 illustrates a high level block diagram of a system 30 that facilitates highlighting identified search results in an electronic document image for presentation to a user, using glyphless font information embedded in the document image. The system 30 comprises the scanner 12, which may be a hardware or software scanner as described above, and which generates a document image 16 that is stored in a document memory 14. The document image additionally has stored therein glyphless font information that describes the size (e.g., height and width) of any font used in the document image. A user interface permits a user to view the document image 16 and to enter search queries to search for characters or text in the document. A searcher 22 then employs an OCR component to identify the queried characters or text, as described above.

The searcher additionally comprises one or more computer-executable algorithms 32 for highlighting query results for presentation to the user via the user interface 20. For instance, a processor 34 can execute an algorithm for identifying a width of a highlighting block that is overlaid on the searched term to identify an occurrence of the searched term as a result to the user. In this example, the algorithm can involve identifying a width and/or height for each character in the queried term, and can sum the widths to determine a length for the highlight block. According to one aspect, the height of the tallest character in the queried term is used the height of the highlight block. According to another aspect, height of the highlight block is determined as the difference between the highest point of a tallest character in the queried term and a lowest point of any character in the queried term, wherein the lowest point of a character may be below a baseline upon which the search term rests. For example, if the term “glyphless” were queried, then the height of the block could be defined as the distance between the top of a tallest character (e.g., an “l” or “h”) and the bottom of a sub-baseline character (e.g., a “g,” “y,” or “p”). According to yet another aspect, the algorithm employs a height for each individual character to form-fit the highlight block to the query result term.

In other examples, algorithms are provided that adjust the highlight block according to detected conditions, such as format (e.g., bold, italics, etc.) of a search result. For instance, a bolded word will have a greater width than unformatted text, and the highlight block can be adjusted accordingly to fit over the bolder search result. Similarly, italicized search results will be slanted slightly, and a rotation angle or slant can be applied to the highlight block to alter it from a substantially rectangular shape to a parallelogram or the like, in order to form-fit the highlight block over the queried search result. In this manner, text can be highlighted in the image document by overlaying the highlight block accurately over the compressed image of the searched term without rendering the text and without overlapping characters that are not part of the searched term.

The searcher additionally comprises a memory 36 that stores user query information, query results, and any other information suitable or related to performing the various functions described herein. For instance, the memory 36 can temporarily store glyphless font information 18 read from the document image 16 being searched at a given time. Such font information can then be erased or overwritten when the document image file is no longer open.

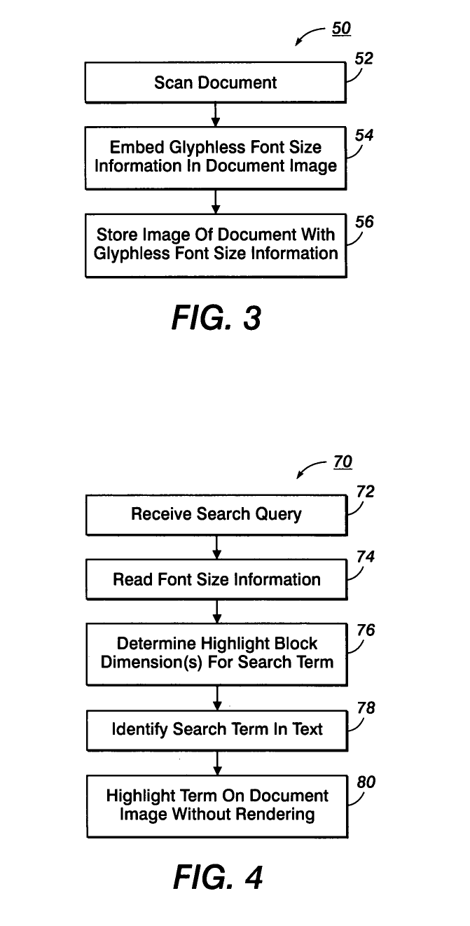

FIGS. 3-5 illustrate one or more methods related to . . . , in accordance with various features. While the methods are described as a series of acts, it will be understood that not all acts may be required to achieve the described goals and/or outcomes, and that some acts may, in accordance with certain aspects, be performed in an order different that the specific orders described.

FIG. 3 illustrates a method 50 of minimizing increases to a scanned document image file size while providing sufficient font size information to facilitate highlighting search terms identified in the document image in response to a user query. At 52, a document is scanned using a scanner that generates a PDF or XPS document or the like. Scanning can be performed using a hardware-based scanner, such as a office scanner or the like, and/or can be performed using a software-based scanner, such as a computer-executable application that converts an electronic data file to a PDF or XPS formatted file. The scanner detects font types present in the document, and embeds font-size information descriptive of the width and/or height of text characters in the font, at 54. This information, being related only to character font size, is glyphless font size information, and is stored with the scanned document image, at 56, for subsequent retrieval and use when searching the document.

FIG. 4 is an illustration of a method 70 of employing glyphless font information to identify text search results in an electronic image of a document, without a font definition file embedded in the image of the document. At 72, a search query is received. For instance, a user can input a search term or phrase into an input device, and a searching algorithm, such as an OCR program or the like can identify one or more search results matching the user's query. At 74, font size information is read from the image document. The font-size information is glyphless, in that it need not contain any information beyond character dimension information. According to an example, the glyphless font size information includes height and width information for each character that is included in the font type.

At 76, dimensions for a highlight block that will fit the search term are determined. According to one example, a width dimension is determined for the queried term, such as by adding the widths of individual characters in the term. Space between characters in the queried term may be accounted for as well, and may be added to the aggregate width of the characters in the term. Additionally, a small buffer width may be added to the determined width dimension, so that the highlight block extends slightly beyond the search term when overlaid thereon. A height dimension for the highlight block can also be determined at 76, and may be predefined for a given font size, or may be determined as a function of a tallest character in the queried term. In the latter case, the entire highlight block can be generated at or near the height of the tallest character in the queried term, forming a substantially rectangular highlight block. In another example, the highlight block can be form-fitted to the queried term.

At 78, the instances of the queried term or phrase can be identified in the document image. Queried terms can be identified using, for example, an OCR technique or the like. According to some aspects, acts 76 and 78 may be performed in reverse order or in parallel, depending on processing capabilities, system requirements, user or designer preferences, etc. At 80, search results (e.g., instances of the queried term) are highlighted by overlaying the generated highlight block on the document image without rendering the underlying text characters. In this manner, a searchable electronic document image can be maintained at a small compressed file size while providing enough font information to permit highlighting of query results for presentation to a user.

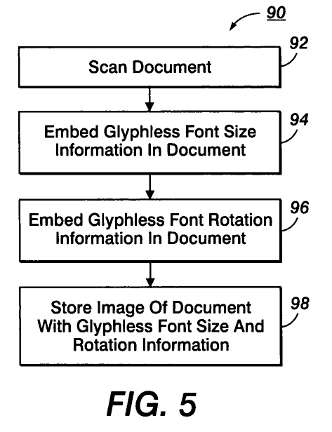

FIG. 5 illustrates a method 90 of providing extended glyphless font size information, in addition to simple character dimension information, without embedding a full font definition file, to facilitate presenting highlighted search term results to a user. At 92, a document is scanned using a scanner that generates a PDF or XPS document, or the like. The scan of the document can be performed using a hardware-based scanner and/or a software-based scanner, such as a computer-executable application that converts an electronic data file to a PDF or XPS formatted file. The scanner detects font types present in the document, and embeds font-size information descriptive of the width and/or height of text characters in the font, at 94. At 96, glyphless font rotation information is embedded into the document. The font rotation information describes a degree of rotation or slant for italicized characters, such as may be employed to rotate the vertical edges of a highlight block in a clockwise direction to slant the highlight block to be congruent to the slant of the queried term. The glyphless font size and rotation information is stored with the scanned document image, at 98, for subsequent retrieval and use when searching the document.

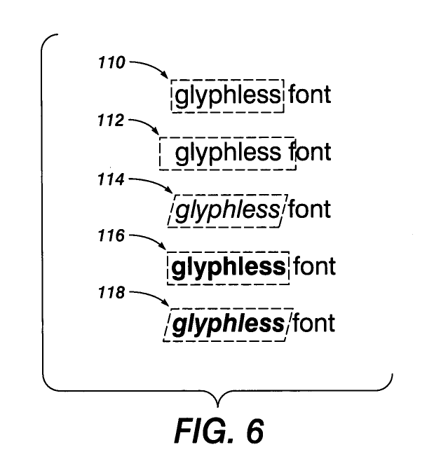

FIG. 6 illustrates several examples of search results that can be presented by the systems and methods described herein, as well as one example of an undesirable search result presentation that is mitigated by the systems and methods described herein. The first example 110 illustrates a highlighted search result that might be presented if a search for “glyphless” were performed on an image of this document. The word “font” is shown to illustrate a spatial relationship between words and to show the fitted highlight block described herein. As illustrated, example 110 shows a rectangular highlight block overlaid on the search result for the queried term. Example 112 illustrates an undesirable highlight block size, such as can be mitigated by the present systems and methods. Example 114 illustrates a highlight block that has been generated using both font character dimension information (e.g., width and/or height information) as well as rotation information. Example 116 illustrates a highlight block that has been generated for a bolded search term. Example 118 shows a highlight block generated using font character dimension information for bolded characters as well as rotation information for italicized characters.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of highlighting a searched term in an electronic document image, comprising:
receiving a search query for a term in the document image;
reading glyphless font size information embedded in the document image;
determining at least one dimension for a highlight block for the search term from the glyphless font size information;
identifying the search term in the document image; and
overlaying the highlight block on the identified search term.

2. The method of claim 1, further comprising embedding the glyphless font size information in the document image when the document is scanned.

3. The method of claim 2, further comprising storing the document image with the embedded glyphless font information.

4. The method of claim 3, wherein the document image is scanned and stored in at least one of a portable document format (PDF) and an XML paper specification (XPS) format.

5. The method of claim 1, at least one dimension of the highlight block is a width of the highlight block, which is calculated by adding the widths of individual characters in the search query term.

6. The method of claim 5, wherein the width of each character in a given font appearing in the document image is stored in the embedded glyphless font size information.

7. The method of claim 1, wherein the glyphless font size information includes a width of each character of a given font, and rotation information for italicized characters of the given font.

8. The method of claim 7, wherein the rotation information describes a degree of slant exhibited by italicized characters.

9. The method of claim 8, wherein the highlight block is generated with a width substantially equal to the sum of the widths of all characters in the search query term, and with a slant substantially equal to the slant of the italicized characters, such that the highlight block exhibits a substantially parallelogram shape, when an italicized search query term is identified.

10. The method of claim 7, wherein glyphless font size information includes a height of each character of a given font, which is employed to determine a height for the highlight block.

11. The method of claim 1, wherein the glyphless font size information is embedded with an overall file size of approximately one kilobyte to approximately 10 kilobytes.

12. A system that facilitates highlighting search terms in an electronic document image, comprising:
a scanner that scans a document and embeds glyphless font size information into an electronic image of the document;
a searcher with an optical character recognition (OCR) component that identifies a search term in the document image in response to a user query; and
a processor that generates a highlight block of a variable width and overlays the highlight block on identified search terms in the document image.

13. The system of claim 12, wherein the glyphless font size information describes a width of each character included in a given font.

14. The system of claim 13, wherein the processor generates the highlight block to have a width substantially equal to the sum of the widths of all characters in the search term.

15. The system of claim 13, wherein the glyphless font size information includes a width of each character of a given font, and rotation information for italicized characters of the given font.

16. The system of claim 15, wherein the rotation information describes a degree of slant exhibited by italicized characters in the given font.

17. The system of claim 15, wherein the processor generates the highlight block with a width substantially equal to the sum of the widths of all characters in the search term, and with a slant substantially equal to the slant of the italicized characters, such that the highlight block exhibits a substantially parallelogram shape, when an italicized search term is identified.

18. The system of claim 12, further comprising a user interface into which a user enters the search term and via which the document image is displayed to the user.

19. The method of claim 12, further comprising a memory that stores the document image in at least one of a portable document format (PDF) and an XML paper specification (XPS) format.

20. A scanning platform, comprising:
one or more xerographic components that execute instructions for performing a xerographic process;
a scanner that scans a document and embeds glyphless font size information, which comprises character dimension information describing dimensions of all characters in a given font, into an electronic image of the document;
a searcher with an optical character recognition (OCR) component that identifies a search term in the document image in response to a user query; and
a processor that generates a highlight block having a width substantially equal to the sum of the widths of the characters in the search term and overlays the highlight block on identified search terms in the document image.
